(19) United States
(12) Patent Application Publication
(10) Pub. No.: US 2025/0131344 A1
(43) Pub. Date: Apr. 24, 2025

(54) SYSTEM AND METHOD FOR CONTROLLING PRODUCT PRICE ADJUSTMENTS

(71) Applicant: Walmart Apollo, LLC, Bentonville, AR (US)

(72) Inventors: Huidong Zhang, Cupertino, CA (US); Weihang Ren, Foster City, CA (US); Lijie Wan, Mountain View, CA (US)

(21) Appl. No.: 18/490,371

(22) Filed: Oct. 19, 2023

(51) Int. Cl. G06Q 10/04; G06Q 30/0202

(52) U.S. Cl. CPC G06Q 10/04; G06Q 30/0202

(57) ABSTRACT

System and methods for controlling product price adjustments are disclosed. In some embodiments, a disclosed method includes: identifying, based on the historical product data, one of more products from the plurality of products for implementation of a markdown, receiving, from a user interface, a plurality of market inputs associated with the one or more products, generating an optimal time period and optimal markdown value associated with the markdown of the one or more products, and mapping the one or products to a prioritization indication based on the optimal time period and the optimal markdown value.

### TECHNICAL FIELD

This application relates generally to managing retail products and, more particularly, to systems and methods for controlling product price adjustments.

### BACKGROUND

Retailers on consistently adjusting the price of products they sell to increase overall revenue. Retailers may markdown prices of products to help clear excess inventory and generate additional revenue For example, retailers may reduce the price of a product to increase sales of products, overall gross merchandise value (GMV) and overall revenue for the retailer. However, retailers face difficulties in the implementation of markdowns because of challenges in manually determining the value or percentage to markdown a product, markdown timing and selecting the right item-store for markdown.

Current methods of implementing product markdowns require a retailer to manually determine which products need to be marked down, when to markdown and how much to markdown based on manual review of inventory. It raises a significant burden on merchant operations and results in massive markdown cost with loss of sales and GMV. Controlling parameters for implementing a markdown is crucial to ensure inventory are cleared in time while GMV are maximized at the same time. In addition, as demand forecasting and price elasticity are highly affected by various pricing markets, it is necessary to take store locations into consideration. As such, it is challenges and desirable to develop a method to control markdown timing and percentage of right item-store combinations and provide advanced signal for replenishment planning.

### SUMMARY

The embodiments described herein are directed to systems and methods for controlling product price adjustments.

In various embodiments, a system including a database storing historical product data associated with a plurality of products, a computing device comprising at least one processor in communication with the database, the computing device being configured to identify, based on the historical product data, one of more products from the plurality of products for implementation of a markdown, receive, from a user interface, a plurality of market inputs associated with the one or more products, generate an optimal time period and optimal markdown value associated with the markdown of the one or more products, and mapping the one or products to a prioritization indication based on the optimal time period and the optimal markdown value.

In some embodiments, the computing device is further configured to: generate, based on the prioritization indication, a markdown plan associated with the one or more products, and display, via a user interface, the markdown plan to a user, the user interface configured to receive one or more user-specific constraints.

In some embodiments, wherein the computing device is further configured to: in response to generation of the markdown plan, transmit the markdown plan to one or more retailers for implementation of the markdown of the one or more products.

In some embodiments, the computing device is further configured to: in response transmitting the markdown plan, automatically update an inventory of the one or more products via an inventory replenishment system.

In some embodiments, the computing device is further configured to in response transmitting the markdown plan, automatically update a price of the one or more products with an updated price based on the generated optimal markdown value.

In some embodiments, the computing device is further configured to: in response receiving the one or more user constraints, automatically update, via the user interface, the markdown plan.

In some embodiments, the computing device is further configured to: execute, via one or more models, a bi-level optimization model for generating the optimal time period and the optimal markdown value.

In some embodiments, the computing device is further configured to: receive a markdown request from one or more retailers, the markdown request including desired metrics and constraints.

In some embodiments, the computing device is further configured to: generate a projected sell through at out-of-stock date associated with the one or more products, compare the projected sell through at out-of-stock date with a target sell through at out-of-stock date to generate a comparison, the target sell through at out-of-stock date being based on user input via the user interface, and based on the comparison, generate the optimal time period and the optimal markdown value.

In some embodiments, the prioritization indication is based on one or more user specific constraints.

In various embodiments, a computer-implemented method is disclosed. The computer-implemented method includes identifying, based on the historical product data, one of more products from the plurality of products for implementation of a markdown, receiving, from a user interface, a plurality of market inputs associated with the one or more products, generating an optimal time period and optimal markdown value associated with the markdown of the one or more products, and mapping the one or products to a prioritization indication based on the optimal time period and the optimal markdown value.

In some embodiments, the method further includes generating, based on the prioritization indication, a markdown plan associated with the one or more products, and displaying, via a user interface, the markdown plan to a user, the user interface configured to receive one or more user-specific constraints.

In some embodiments, the method further includes in response to generation of the markdown plan, transmitting the markdown plan to one or more retailers for implementation of the markdown of the one or more products.

In some embodiments, the method further includes in response transmitting the markdown plan, automatically updating an inventory of the one or more products via an inventory replenishment system.

In some embodiments, the method further includes in response transmitting the markdown plan, automatically updating a price of the one or more products with an updated price based on the generated optimal markdown value.

In some embodiments, the method further includes in response receiving the one or more user constraints, automatically updating, via the user interface, the markdown plan.

In some embodiments, the method further includes executing, via one or more models, a bi-level optimization model for generating the optimal time period and the optimal markdown value.

In some embodiments, the method further includes receiving a markdown request from one or more retailers, the markdown request including desired metrics and constraints.

In some embodiments, the method further includes generating a projected sell through at out-of-stock date associated with the one or more products, comparing the projected sell through at out-of-stock date with a target sell through at out-of-stock date to generate a comparison, the target sell through at out-of-stock date being based on user input via the user interface, and based on the comparison, generating the optimal time period and the optimal markdown value.

In various embodiments, a non-transitory computer readable medium having instructions stored thereon is disclosed. The instructions, when executed by at least one processor, cause at least one device to perform operations including: identifying, based on the historical product data, one of more products from the plurality of products for implementation of a markdown, receiving, from a user interface, a plurality of market inputs associated with the one or more products, generating an optimal time period and optimal markdown value associated with the markdown of the one or more products, and mapping the one or products to a prioritization indication based on the optimal time period and the optimal markdown value.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to control product price adjustments, in accordance with some embodiments of the present teaching.

FIG. 2 is a block diagram of a product price adjuster, in accordance with some embodiments of the present teaching.

FIG. 3 is a flow diagram of a system for controlling product price adjustments, in accordance with some embodiments of the present teaching.

FIG. 4 is a flow diagram of a markdown engine of the system for controlling product price adjustments of FIG. 3, in accordance with some embodiments of the present teaching.

FIG. 5 is a flow diagram of a markdown engine of the system for controlling product price adjustments of FIG. 3, in accordance with some embodiments of the present teaching.

FIG. 6 is a flowchart illustrating an exemplary method for controlling product allocation in response to market variations, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

The present disclosure provides systems and methods for controlling product price adjustments. In some embodiments, the systems and methods utilize models (e.g., machine learning models) to generate product markdown determinations. The systems and methods provided herein may be used to determine the amount of markdown of a product and when to apply the markdown. For example, the systems and method provided herein may determine the value or percentage of markdown for a product and when to apply the markdown. The systems and methods may then provide a prioritization of the markdown and a markdown plan to implement the markdown.

One goal of the present teaching is to determine the amount of markdown for a product and when to implement the markdown. In some embodiments, a disclosed system utilizes one or more models to determine the amount of markdown and when to apply the markdown. The system can prioritize a plurality of markdowns associated with a plurality of products and generate a business plan for one or more retailers.

In some embodiments, the system allows for the control of product price adjustments. The system may include a markdown engine configured to determine the amount of markdown for one or more products and when to implement the markdown for the one or more products. In some embodiments, the markdown engine is configured to prioritize which markdown to implement first (e.g., generate a ranking of markdowns) and configured to generate a business or markdown plan for one or more retailers.

In some embodiments, the system includes a user interface to provide one or more retailers the markdown plan. The user interface may also provide to the user a prioritization of implementing the markdown or markdown plan. In some embodiments, the system automatically generates the markdown plan and presents the markdown plan to a user. The user may interact with the user interface to adjust one or more constraints or guardrails (e.g., budget constraints, inventory constraints, duration constraints) and, in response, the system may automatically adjust the markdown plan.

In some embodiments, upon generation of the markdown plan, the system is configured to transmit the markdown plan to a user, via the user interface, for approval. The markdown plan may include recommended markdown percentages, markdown spend, projected sell-through lift, and GMV lift. In some embodiments, upon receiving an approval of the markdown plan from a user, via the user interface, the system may transmit new markdown prices for implementation. An upstream inventory system may receive an advanced signal for implementation of the markdown plan and replenishment planning, such as predicted sales velocity and total projected sales by out-of-stock date for retailers or stores that are selected for markdown.

In some embodiments, the system is configured to identify similar products for markdown. For example, the system may identify a product for markdown and may generate markdown values and markdown timings associated with the product. Upon implementation of the markdown, the system may identify other products (e.g., similar products) for markdown to maximize GMV. In some embodiments, the system simultaneously generates markdown values and/or markdown timings and identifies similar products.

Furthermore, in the following, various embodiments are described with respect to methods and systems for controlling product price adjustments. In some embodiments, a disclosed method includes: identifying, based on the historical product data, one of more products from the plurality of products for implementation of a markdown, receiving, from a user interface, a plurality of market inputs associated with the one or more products, generating an optimal time period and optimal markdown value associated with the markdown of the one or more products, and mapping the one or products to a prioritization indication based on the optimal time period and the optimal markdown value.

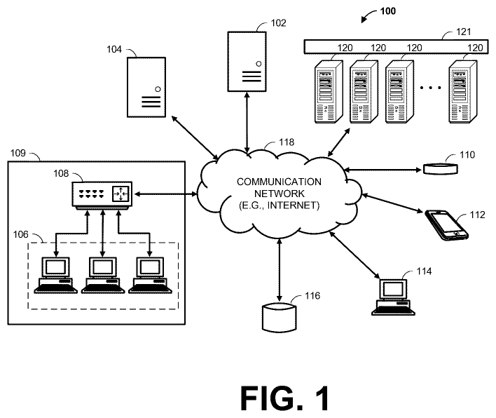

Turning to the drawings, FIG. 1 is a network environment 100 configured to control product price adjustments, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, markdown engine 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The markdown engine 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the markdown engine 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the markdown engine 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites providing one or more products or services. In some examples, the markdown engine 102, the processing devices 120, and/or the web server 104 are operated by a retailer. The multiple user computing devices 110, 112, 114 may be operated by customers or advertisers associated with the retailer websites. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109 of a retailer, for example. The workstation(s) 106 can communicate with the markdown engine 102 over the communication network 118. The workstation(s) 106 may send data to, and receive data from, the markdown engine 102. For example, the workstation(s) 106 may transmit data identifying items purchased by a customer at the store 109 to the markdown engine 102.

Although FIG. 1 illustrates three user computing devices 110, 112, 114, the network environment 100 can include any number of user computing devices 110, 112, 114. Similarly, the network environment 100 can include any number of the markdown engine 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website, such as a retailer's website hosted by the web server 104. The web server 104 may transmit user session data related to a customer's activity (e.g., interactions) on the website.

In some examples, a customer may operate one of the user computing devices 110, 112, 114 to initiate a web browser that is directed to the website hosted by the web server 104. The customer may, via the web browser, view a user interface for viewing and interacting with a markdown plan generated by markdown generator 102. The website may capture these activities as user session data, and transmit the user session data to the markdown engine 102 over the communication network 118. The website, via the user interface, may also allow the user to view the markdown plan associated with one or more products at one or more retail locations. In some examples, the web server 104 transmits user data to the markdown engine 102. The user data may include data associated with the user's interaction with the website via the user interface.

In some examples, a user (e.g., a retailer) may use one of the user computing devices 110, 112, 114 to view, control, and predict markdowns or other business metrics associated with one or more products. The user may use a user interface to view, control, and analyze the various markdowns and/or business metrics associated with one or more products via web server 104. The user may, via the web browser or the user interface, view the markdowns and/or business metrics associated with one or more products. The website may capture at least some of these activities as user data. The web server 104 may transmit the user data to the markdown engine 102 over the communication network 118, and/or store the user data to the database 116.

In some embodiments, the web server 104 transmits a markdown request to the markdown engine 102, e.g. upon a selection of a user to generate a markdown plan. For example, the markdown request may be sent based on the desire of a user to implement a markdown plan to markdown one or more products while maximizing GMV. The markdown request may be sent standalone or together with other related data of the website. In some examples, the markdown request may carry or indicate user data.

In some examples, the markdown engine 102 may execute one or more models (e.g., algorithms), such as a mathematical models, machine learning model, deep learning model, statistical model, etc., to generate and implement markdowns for one or more products. The markdown engine 102 may generate markdown values and markdown timings for maximizing GMV associated with one or more products. In some embodiments, multiple models are executed by the markdown engine 102 to generate markdown values and markdown timings for maximizing GMV associated with one or more products. For example, the markdown engine 102 may execute a first model to generate markdown values and/or markdown timings, may execute a second model to prioritize the generated markdown values and/or markdown timings, and may execute a third model to identify similar products.

The markdown engine 102 is further operable to communicate with the database 116 over the communication network 118. For example, the markdown engine 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the markdown engine 102, in some examples, the database 116 can be a local storage device, such as a hard drive, a non-volatile memory, or a USB stick. The markdown engine 102 may store historical data, business metrics, user data, or data associated with one or more products received from the web server 104 in the database 116. The markdown engine 102 may receive markdown data (e.g., markdown values, markdown timings) and/or business metrics associated with one or more products. In some embodiments, the business metrics include historical data associated with the one or more products. The markdown engine 102 may also receive from the web server 104 user session data identifying events associated with browsing sessions, and may store the user session data in the database 116. Database 116 may be coupled to a computing device. For example, database 116 may be coupled to one or more user computing devices 110, 112, 114 via communication network 118.

In some embodiments, the web server 104 transmits a model training request to the markdown engine 102. Upon the model training request, the markdown engine 102 may retrieve, e.g. from the database 116, historical data associated with performance of the product. The markdown engine 102 may train one or more models using the historical data of the product. The one or more models may be trained to identify products suitable for markdowns. The one or more models may be trained to identify markdown values and/or markdown timings associated with the identified products. In some embodiments, the outputs from the model may be used to refine and train the model. For example, one or more models may be trained using historical data (e.g., past performance of a product) and may generate markdowns associated with the product. The generated markdowns may be compared to actual markdowns associated with the product to generate a comparison value. The comparison value may be inputted into the one or more models to refine the one or more models to make the one or more models more accurate.

The models, when executed by the markdown engine 102, allow the markdown engine 102 to generate markdown data (e.g., markdown values, markdown timings). In some examples, the markdown engine 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the markdown engine 102 may generate markdown data associated with a markdown plan. The markdown engine 102 may provide a user interface to allow a user to interact with the generated markdown data. For example, the user interface may allow a user to view and adjust markdown values and markdown timings associated with the markdown for one or more products.

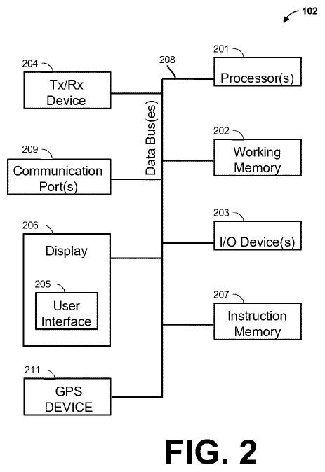

FIG. 2 illustrates a block diagram of a markdown engine, e.g. the markdown engine 102 of FIG. 1, in accordance with some embodiments of the present teaching. In some embodiments, each of the markdown engine 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the markdown engine 102 can be combined, omitted, and/or replicated. In addition, it will be appreciated that additional elements other than those illustrated in FIG. 2 can be added to the markdown engine 102.

As shown in FIG. 2, the markdown engine 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the markdown engine 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the markdown engine 102 can include a single memory unit configured to operate as both instruction memory and working memory. Further, although embodiments are discussed herein including non-volatile memory, it will be appreciated that computing device 110, 112, 114 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS,
SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the markdown engine 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the markdown engine 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the markdown engine 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the markdown engine 102 and/or the web server 104. For example, the user interface 205 can be a user interface for an application of a network environment operator that allows a customer to view and interact with the product management data generated by the markdown engine 102. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the markdown engine 102 may determine a local geographical area (e.g., town, city, state, etc.) of its position.

In some embodiments, the markdown engine 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

The network environment 100 further includes one or more model training systems that are communicatively coupled with at least one or more model database maintaining trained models and one or more training data databases (e.g., database 116) that stores relevant training data to train and/or retrain the one or more models used by the markdown engine 102. The model training system includes one or more model training servers or managers, which are implemented through one or more computing systems, servers, computers, processor and/or other such systems communicatively coupled with one or more of the distributed communication networks 118, and are configured to build and/or train the machine learning models. In some implementations, the model training system includes multiple sub-model training systems each associated with one or more of the different machine learning models.

The training data database stores and updates relevant training data. The training data includes historic data of recipients and their association with known companies, predefined profiles of types of recipients, predefined profiles of known preferences of information, predefined associations of responsibilities to types of recipients and other such information. Further, the training data includes historic sales data (e.g., quantities of products sold, pricing, pricing adjustments, etc.), typically for one or more years, in association with historic inventory information, historic marketing information, and other such information. Some embodiments further include historic markdown data associated with products that have been previously markdown. The training data additionally includes historic information about different information supplied to and/or accessed by different users corresponding to thousands or more products from hundreds of different suppliers and/or manufactures and sold from multiple different retail stores distributed over multiple different geographic areas. Further, the training systems is configured to receive feedback information at least through the graphical user interface corresponding to actions by the different recipients interfacing with the respective graphical user interface based on the rendered customized anomaly notification information. This feedback can include changes in settings, requests for other information, clicks to other information, clicks to more detailed information, tagging of information for another potential recipient, indications of like and/or dislike of information, comments, actions indicating a disregard of types of information, searches performed, subsequent use of information provided, subsequent actions taken by recipients following access to different information, and other such feedback. The training system utilizes the feedback information to repeatedly over time retrain the models to repeatedly provide over time retrained markdown models, retrained contextual models, retrained markdown prioritization models, retrained personalization models, and/or other retrained machine learning algorithms that improve performance over time and enhance the identification of anomalies, and the identification of information that is more relevant to the invented recipient.

The training data databases (e.g., database 116) can be local to the model training system, remote and accessible over one or more of the communication networks 118 or a combination of local and distributed. The model training system uses the relevant machine learning data to train the machine learning models. In some embodiments, one or more training processes are similar to the process performed by one or more models after having been trained, but can be trained with multiple sets of training data (e.g., some real and some simulated or synthetic for training). Predictions are compared to actuals to ensure that the set of models are operating with a certain threshold confidence. Further, the model training system is configured to receive feedback information through the graphical user interface corresponding to actions by the recipient interfacing with the graphical user interface.

The above and below description includes descriptions of embodiments implementing and/or utilizing trained machine learning models and/or neural networks. In some embodiments, the neural network, machine learning models and/or machine learning algorithms may include, but are not limited to, Heuristics, Univariate based techniques, Multivariate, control limit, isolation forest and LOF-ensembles, deep learning models such as LSTM-based autoencoders, variational autoencoders, deep stacking networks (DSN), Tensor deep stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such models, networks and/or algorithms.

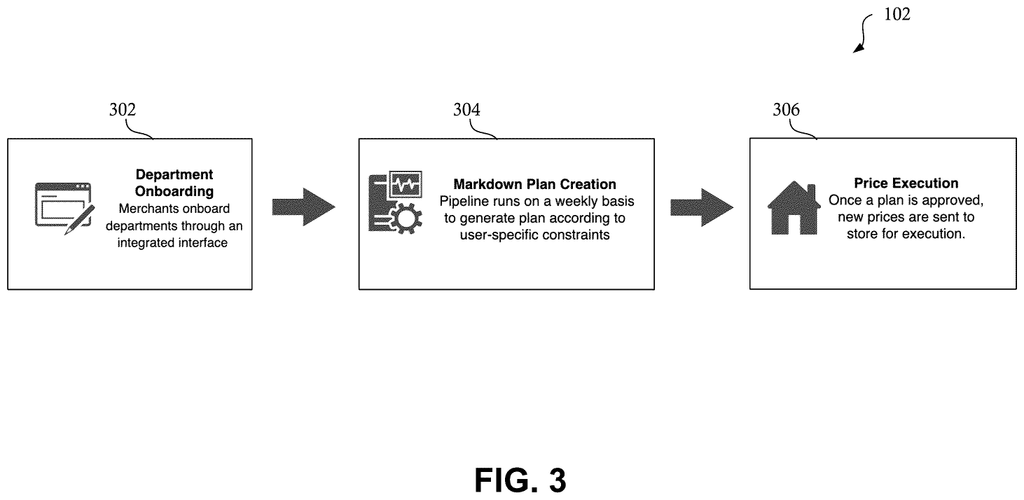

FIG. 3 is a flow diagram of markdown engine 102, in accordance with some embodiments of the present teaching. As indicated in FIG. 3, markdown engine 102 may be configured to receive information from one or more retailers (e.g., merchants) through a user interface. The information may include a request to generate a markdown and/or a markdown plan. In some embodiments, markdown engine 102 is configured to generate a markdown plan and transmit the markdown plan to one or more stores or retailers.

In some embodiments, markdown engine 102 is configured to identify one or more products for markdown. For example, markdown engine 102 may use one or more models (e.g., mathematical optimization models, machine learning models) to identify products that need to be marked down in price to maximize GMV and ensure a target inventory. In some embodiments, markdown engine 102 trains one or more models using historical performance data associated with one or more products to predict and identify products that need price markdowns.

For example, markdown engine 102 may be configured to execute department onboarding 302, markdown plan creation 304, and price execution 306. In some embodiments, to initiate the markdown generation process for a product, markdown engine 102 executes department onboarding 302. For example, markdown engine 102 may receive parameter inputs specified by one or more retailers through a user interface. The parameter inputs may include maximum & minimum markdown duration, target sell-through, time needed for price execution and ceiling & floor of markdown percentage. Upon completion of the department onboarding (e.g., receiving the parameter inputs), markdown engine 102 is configured to generate a markdown plan according to user-specific constraints that are associated with the parameter inputs. Markdown engine 102 may include a generation module and a prioritization model. In some embodiments, the generation module is configured to generate markdown data (e.g., markdown values and markdown timings) and the prioritization module is configured to prioritize the generated markdown data for transmission to one or more retailers. In some embodiments, upon generation of the markdown data, markdown engine 102 is configured to generate a markdown plan based on the markdown data. The markdown plan may be transmitted to one or more retailers for implementation or execution. Upon receiving the markdown plan, the one or more retailers may implement the markdown plan to generate markdown prices for one or more products. Upon implementation, new prices (e.g., markdown prices) for the one or more products are executed. In some embodiments, upon execution of the markdown plan generated by markdown engine 102, markdown engine 102 is configured to generate projected sales to upstream inventory systems. This allows for the upstream inventory systems to replenish the inventory based on the generated projected sales.

### Patent

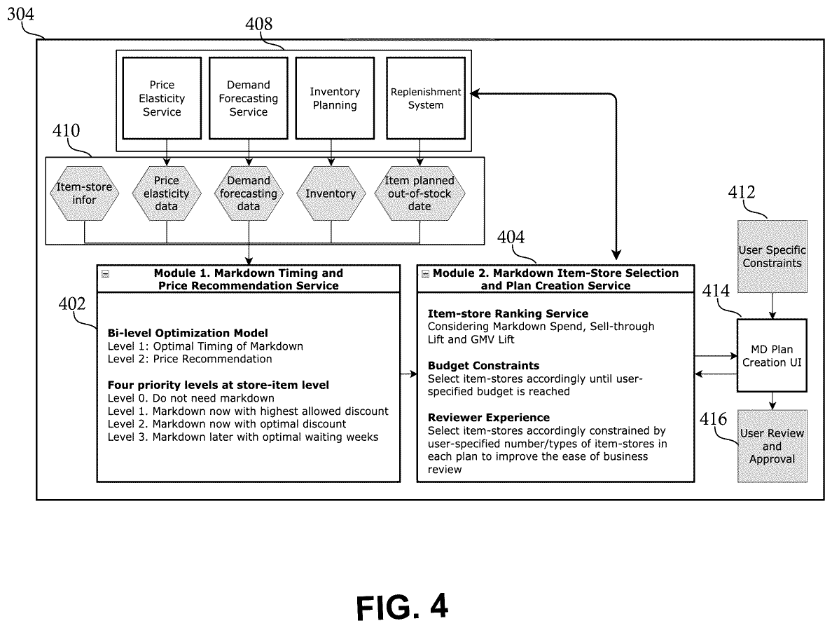

FIG. 4 is a flow diagram of markdown plan creation 304 executed by markdown engine 102. Markdown engine 102 may include generation module 402 and prioritization module 404. Generation module 402 may be configured to generate markdown values (e.g., price or percentage decrease) and/or markdown timing (e.g., when to apply the markdown) for one or more products. Generation module 402 may generate markdown data (e.g., markdown values and/or markdown timing) and transmit the markdown data as a markdown plan. The markdown plan may include the markdown data and may be generated by generation module 402.

In some embodiments, generation module 402 is configured to generation markdown data (e.g., optimal timing and markdown percentage) for one or more products for one or more retailers. Generation module 402 may be configured to generate a markdown data including projected markdown spend, GMV lift and sell-through lift for each product upon execution and implementation of the generation markdown plan. Generation module 402 is configured to generate markdown data based on market inputs 410 from corresponding services such as third party databases and/or inputs from a user via a user interface.

In some embodiments, market inputs 410 are retrieved from one or more sources 408. For example, market inputs 410 may include item-store attribute, price elasticity, demand forecasting, inventory level and item planned out-of-stock date. Market inputs 410 may be retrieved from sources 408 by a user or generation module 402. Sources 408 may include price elasticity service, demand forecasting service, inventory planning, or replenishment system. In some embodiments, each of sources 408 is a component of network environment 100. For example, network environment 100 may include one or more of price elasticity service, demand forecasting service, inventory planning, or replenishment system, each of which is configured to communicate with markdown engine 102.

In some embodiments, market inputs 410 includes one or more constraints or guardrails. For example, market inputs 410 may include user inputted constraints or system generated constraints. The constraints may include budget constraints, markdown constraints, timing constraints, inventory constraints etc. For example, the markdown constraints may include the highest percentage or price for markdown and lowest percentage or price for a markdown. By way of another example, the timing constraints may include the longest duration or time to implement a markdown or the shortest duration or time to implement the markdown.

In some embodiments, generation module 402 is configured to leverage a bi-level optimization model to generate for the optimal markdown timing and markdown percentage for one or more products associated with one or more retailers. Generation module 402 may be configured to generate optimal markdown timing and markdown percentage while maximizing a gross merchandise value (GMV) associated with the one or more products in addition ensuring target sell-through at a planned out-of-stock date.

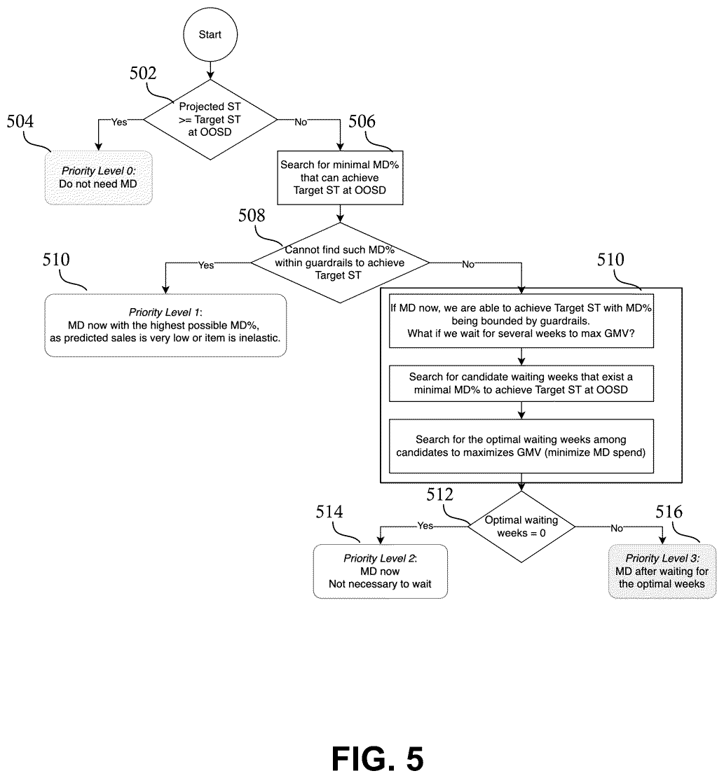

FIG. 5 is a flow diagram of generation module 402. Generation module 402 may be configured to generate a markdown timing to apply a markdown to a product. The markdown timing may when the product should be markdown to ensure that the overall GMV is maximized for the desired product. In some embodiments, generation module 402 receives market inputs 410, which includes item planned-out of stock date. In some embodiments, generation module 402 utilizes one or more models and historical performance of the product to generate a projected/planned out of stock date. Generation module 402 may be configured to generate a markdown timing that ensures that the target sell-through is at the projected out-of-stock date.

Based on market inputs 410 (e.g., demand forecasting data) for each product, generation module 402 generates a projected sell-through at an out-of-stock date for the desired product. For example, generation module 402 may receive one or more market inputs 410 and may generate a projected sell through at out-of-stock date. This may be the date estimated by generation module 402 to be the date in which the product is sold through completion of the inventory. In some embodiments, generation module 402 utilizes one or more models and historical product performance data to generate the projected sell-through at out-of-stock date.

With continued reference to FIG. 5, generation module 402 may be configured to tag or mark each product with a specific prioritization indication. In some embodiments, generation module 402 is configured to map each product to a specific prioritization indication The prioritization indication may indicate the markdown timing and the markdown value (e.g., price reduction or percentage reduction). For example, generation module 402 may tag or mark each product with Priority Level 0, 1, 2, or 3. In some embodiments, markdown engine 102 determines, via one or more models, using historical performance data, that the product is going to have low sales due to one or more causal factors (e.g., decreasing market space, competitors, seasonal changes, etc.). In some embodiments, markdown engine 102 analyzes the performance of the product and generates a performance indicator. The performance indicator may indicate the strength of performance of the product, such as the product having increasing sales or having low sales.

Generation module 402 may tag or mark the product with the prioritization indication upon receipt of a markdown request. Priority Level 0 may indicate that the product does not require a markdown. This may be due to the product selling at a rate that, for example, maximizes GMV and thus not require any markdown. Priority Level 1 may indicate that generation module 402 determines, via one or more models, that the product requires a markdown immediately and the markdown value should be as high as possible (e.g., highest possible markdown percentage). This may be due to the product having low predicated sales or the item being inelastic. Priority Level 2 may indicate that generation module 402 determines, via one or more models, that the product should receive a markdown immediately with the minimal markdown value determined by generation module 402. For example, generation module 402 may determine that a product needs to receive a markdown immediately, but that the markdown value can remain higher than Priority Level 1. Priority Level 3 may indicate that generation module 402 determines, via one or more models, that the product should receive a markdown after waiting for a predetermined number of weeks. In some embodiments, generation module 402 determines the predetermined number of weeks based on historical product performance data of the product.

Generation module 402 may determine the optimal markdown timing and the optimal markdown value. At operation 502, generation module 402 compares the projected sell-through at out-of-stock date generated by generation module 402 to a target sell-through at out-of-stock date. In some embodiments, out of stock date (OOSD) is obtained from replenishment system. Target sell-through rate at OOSD may be based on user input via the user interface. Projected sell-through may indicate the predicted sell-through at OOSD under the current price obtained with demand forecasting data.

At operation 504, generation module 402 may mark or tag the product as Priority Level 0 if the projected sell-through at out-of-stock date is greater than or equal to the target sell-through out-of-stock date. At operation 506, generation module 402 may search for the minimal markdown value that will achieve the target sell-through at out-of-stock date, if the projected sell-through at out-of-stock date is less than the target sell-through out-of-stock date. For example, if the projected sell-through at out-of-stock date is less than the target sell-through out-of-stock date, generation module 402 may determine which markdown value (e.g., markdown price reduction or percentage decrease in price) may result in the projected sell-through at out-of-stock date being greater than or equal to the target sell-through out-of-stock date. In some embodiments, generation module 402, at operation 506 determines the minimal markdown percentage that can achieve target sell-through using one or more models utilizing market inputs 410 (e.g., demand forecasting and price elasticity data).

At operation 508, generation module 402 may not be able to determine a markdown value within constraints of market inputs 410 to achieve the target sell-through at out-of-stock date. For example, the product may need to be marked down immediately with the highest possible markdown value due generation module 402 predicting sales of the product to be extremely low and/or the product being inelastic. In response, generation module 402 may mark or tag the product with prioritization indication of Priority Level 1.

At operation 508, if generation module 402 is able to determine a markdown value within constraints of market inputs 410 to achieve the target sell-through at out-of-stock date, then, at operation 510, marking down the product immediately may achieve target sell-through with markdown percentage being bounded by the constraints. This may indicate that waiting for a predetermined amount of time may result in the product being able to achieve target sell-through with an increased markdown percentage but an increased overall GMV. Generation module 402 may be configured to identify an optimal time period (e.g., optimal waiting period) to implement the markdown within the constraints. In some embodiments, generation module 402 utilizes a bi-level optimization model. The first level of the bi-level optimization model may include identifying an optimal time period and the second level may include identifying a corresponding markdown value. If generation module 402 determined that the optimal time period is zero, then this indicates that the product needs to be marked down immediately with an optimal markdown value generated by generation module 402. At operation 514, generation module 402 may mark or tag the product with prioritization indication of Priority Level 2.

At operation 516, when the optimal time period is greater than zero, generation module 402 may determine that the product can be marked down after a predetermined time period with its corresponding optimal markdown value determined by generation model 402. This may generate an increased overall GMV as compared with marking down the product immediately. Generation module may mark or tag the product as Priority Level 3.

In some embodiments, generation module 402 utilizes one or more calculations to determine the time period for implementing a markdown to maximize one or more business metrics, such as GMV. For example, one or more parameters, such as those listed in Table 1 below, may be used to generate and calculate time periods for implementing a markdown.

TABLE 1

| Para- | |
|---|---|
| meter | Description |
| x | Discrete decision variable denoting the markdown |
| | percentage x ϵ X, where X = {x^{lb}, x^{lb} + 0.1%, . . . , |
| | x^{ub}} is the set of candidate markdown percentage, |
| | x^{lb} and x^{ub} are lower and upper bound of |
| | markdown percentage |
| y | Discrete decision variable denoting waiting weeks, |
| | y ϵ [symbol] , where [symbol] = {0, 1, . . . , T − T_{MD}^{lb} − |
| | T^{exe}} is the set of candidate waiting weeks, T |
| | indicates weeks remaining, the T_{MD}^{lb} is the lower |
| | bound of MD duration, T^{exe} is number of execution |
| | weeks |
| p | Current retail price |
| I | Current on-hand inventory |
| R | Target sell-through, e.g. 100% |
| ε_{x,t} | Elasticity of markdown percentage x at week t, |
| | ε_{x,t} ϵ (−∞, 0) |
| qₜ | Predicted weekly demand at week t |
| q₀ | Predicted weekly demand during execution week |

For each product, if generation module determine (q₀+Σₜ₌₁^{T}q^{t})I≥R, then the product is tagged as Priority Level 0 (e.g., the product does not need markdown). Otherwise, generation module 402 may utilize an optimization model to search for the minimal markdown value x* that can achieve target sell-through R. The optimization model may be based on the following calculations:

$${x}^{*} = {arg min}_{x ∈ 𝒳} x$$

$$s . t . \frac{{q}_{0} + {\sum }_{t = 1}^{T} {{q}_{t} ( 1 - x )}^{{ε}_{x , t}}}{I} \geq R$$

In some embodiment, generation module 402 determines that no feasible solution can be found within the constraints, the product is tagged as Priority Level 1 (e.g., the product needs to be marked down immediately with the highest possible value percentage within the constraints). Otherwise, generation module 402 generates and utilizes a bi-level optimization model to search for the optimal time period y* which maximizes GMV and ensures target sell-through. The bi-level optimization model may be based on the following calculations:

$${y}^{*} = arg {max}_{y ∈ 𝒴} {\sum }_{t = 0}^{y} {q}_{t} p + min \{ I - {\sum }_{t = 0}^{y} {q}_{t} , {\sum }_{t = y + 1}^{T} {{q}_{t} ( 1 - {x}^{*} )}^{{ε}_{{x}^{*} , t}} \} \cdot ( 1 - {x}^{*} ) p$$

In some embodiments, if y*=0, generation module 402 marks or tags the product Priority Level 2 (e.g., the product needs to be marked down immediately with an optimal markdown value). Otherwise y*>0, generation module 402 marks or tags the product as Priority Level 3 (e.g., the product needs to be marked down after the optimal time period y*has passed).

Referring to FIG. 4, markdown engine 102 may include prioritization module 404. In response to generation module 402 generating the optimal time period, prioritization module 404 may generate a prioritization within each prioritization indication. Prioritization module 404 may receive from generation module 402 the optimal time period and the optimal markdown value generated by generation module 402. Prioritization module 404 may be configured to automatically, in response to receiving the generated optimal time period and optimal markdown value, generate a markdown plan. The markdown plan may be generated based on user specific constraints 412. In some embodiments, prioritization module 404 transmits the markdown plan to a user interface for presentation or display to a user. The user may interact with or adjust the markdown plan via the user interface. In some embodiments, in response to interaction or adjustment of the markdown plan by a user via the user interface, prioritization module 404 is configured to automatically update the markdown plan.

In some embodiments, prioritization module 404 generates a plurality of markdown metrics. The markdown metrics may include markdown spend, sell through lift, and GMV lift. In some embodiments, markdown spend is the current price of the product multiplied by the markdown value (e.g., markdown percentage) multiplied by the on hand inventory. The sell through lift may be the difference between the sell through of the product with implementation of the markdown plan and the sell through of the product without any markdown. The GMV lift may be the difference between the GMV of the product with implementation of the markdown plan and the GMV of the product without any markdown.

In some embodiments, within each prioritization indication, prioritization module 404 ranks or prioritizes products according to the markdown metrics. Prioritization module 404 may generate an average ranking based on:

$$Average Ranking = ( Markdown Spend Ranking + Sell Through Lift Ranking + GMV Lift Ranking ) / 3$$

Prioritization module 404 may generate final rankings by sorting Average Ranking in a predetermined order (e.g., ascending order). In some embodiments, the generated final rankings are transmitted to creation interface 414. In some embodiments, creation interface 414 is configured to generate a markdown plan in response to a selection of product within a specific prioritization indication until a user-specific budget is reached. Creation interface 414 may be configured to transmit user inputs to prioritization module 404 and/or generation module 402.

In some embodiments, upon creation of the markdown plan, the markdown plan is transmitted to a user at operation 416. The markdown plan may be sent to the user for approval with detailed information including recommended markdown values, markdown spend, projected sell-through lift and GMV lift in total and for each selected product. Upon indication of an approval by the user, new markdown prices will be sent to the one or more retailers for the one or more products for execution. In some embodiments, upstream inventory systems receive an advanced signal for replenishment planning. For example upstream inventory systems may receive predicted sales velocity and total projected sales by out-of-stock date for one or products that are selected for markdown from markdown engine 102.

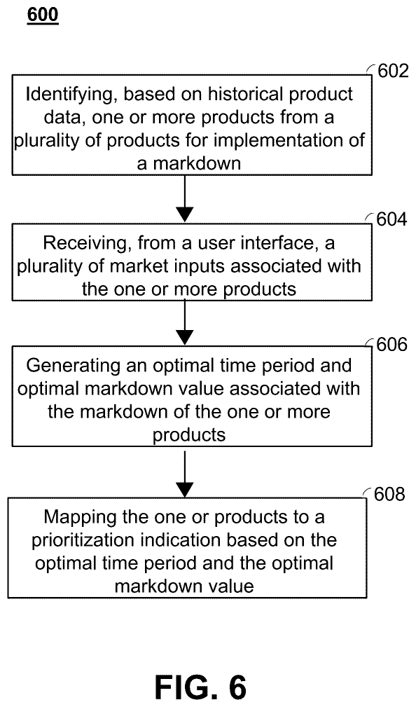

FIG. 6 is a flowchart illustrating an exemplary method for controlling product price adjustments in response to market variations based on generating causal analysis. At operation 602, markdown engine 102 may identify, based on the historical product data, one or more products from the plurality of products for implementation of a markdown. For example, markdown engine 102 may, based on historical performance of a plurality of products, identify one or more products for markdown in price. These may be products that have decreasing or low performance. At operation 604, markdown engine 102 may receive, from a user interface, a plurality of market inputs associated with the one or more products. In some embodiments, markdown engine 102 receives user specific constraints, such as high and low markdown durations and/or values. At operation 606, markdown engine may generate an optimal time period and optimal markdown value associated with the markdown of the one or more products. The optimal time period and optimal markdown value may be generated by markdown engine 102 to maximize GMV of the one or more products. At operation 608, markdown engine 102 may map the one or products to a prioritization indication based on the optimal time period and the optimal markdown value. For example, markdown engine 102, via prioritization module 404, may map a priority level (e.g., Priority Level 0, 1, 2, 3) to the one or more products based on the generated optimal time period and/or optimal markdown value.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a database storing historical product data associated with a plurality of products;
a computing device comprising at least one processor in communication with the database, the computing device being configured to:
identify, based on the historical product data, one or more products from the plurality of products for implementation of a markdown;
receive, from a user interface, a plurality of market inputs associated with the one or more products;
generate an optimal time period and optimal markdown value associated with the markdown of the one or more products; and
map the one or products to a prioritization indication based on the optimal time period and the optimal markdown value.

2. The system of claim 1, wherein the computing device is further configured to:
generate, based on the prioritization indication, a markdown plan associated with the one or more products; and
display, via a user interface, the markdown plan to a user, the user interface configured to receive one or more user-specific constraints.

3. The system of claim 2, wherein the computing device is further configured to:
in response to generation of the markdown plan, transmit the markdown plan to one or more retailers for implementation of the markdown of the one or more products.

4. The system of claim 3, wherein the computing device is further configured to:
in response transmitting the markdown plan, automatically update an inventory of the one or more products via an inventory replenishment system.

5. The system of claim 3, wherein the computing device is further configured to:
in response transmitting the markdown plan, automatically update a price of the one or more products with an updated price based on the generated optimal markdown value.

6. The system of claim 2, wherein the computing device is further configured to:
in response receiving the one or more user constraints, automatically update, via the user interface, the markdown plan.

7. The system of claim 1, wherein the computing device is further configured to:
execute, via one or more models, a bi-level optimization model for generating the optimal time period and the optimal markdown value.

8. The system of claim 1, wherein the computing device is further configured to:
receive a markdown request from one or more retailers, the markdown request including desired metrics and constraints.

9. The system of claim 1, wherein the computing device is further configured to:
generate a projected sell through at out-of-stock date associated with the one or more products;
compare the projected sell through at out-of-stock date with a target sell through at out-of-stock date to generate a comparison, the target sell through at out-of-stock date being based on user input via the user interface [; and
based on the comparison, generate the optimal time period and the optimal markdown value.

10. The system of claim 1, wherein the prioritization indication is based on one or more user specific constraints.

11. A computer-implemented method, comprising:
identifying, based on historical product data, one or more products from a plurality of products for implementation of a markdown;
receiving, from a user interface, a plurality of market inputs associated with the one or more products;
generating an optimal time period and optimal markdown value associated with the markdown of the one or more products; and
mapping the one or products to a prioritization indication based on the optimal time period and the optimal markdown value.

12. The method of claim 11 further comprising:
generating, based on the prioritization indication, a markdown plan associated with the one or more products; and
displaying, via a user interface, the markdown plan to a user, the user interface configured to receive one or more user-specific constraints.

13. The method of claim 12 further comprising:
in response to generation of the markdown plan, transmitting the markdown plan to one or more retailers for implementation of the markdown of the one or more products.

14. The method of claim 13 further comprising:
in response transmitting the markdown plan, automatically updating an inventory of the one or more products via an inventory replenishment system.

15. The method of claim 13 further comprising:
in response transmitting the markdown plan, automatically updating a price of the one or more products with an updated price based on the generated optimal markdown value.

16. The method of claim 12 further comprising:
in response receiving the one or more user constraints, automatically updating, via the user interface, the markdown plan.

17. The method of claim 11 further comprising:
executing, via one or more models, a bi-level optimization model for generating the optimal time period and the optimal markdown value.

18. The method of claim 11 further comprising:
receiving a markdown request from one or more retailers, the markdown request including desired metrics and constraints.

19. The method of claim 11 further comprising:
generating a projected sell through at out-of-stock date associated with the one or more products;
comparing the projected sell through at out-of-stock date with a target sell through at out-of-stock date to generate a comparison, the target sell through at out-of-stock date being based on user input via the user interface; and
based on the comparison, generating the optimal time period and the optimal markdown value.

20. A non-transitory computer readable medium having instructions stored thereon, wherein the instructions, when executed by at least one processor, cause at least one device to perform operations comprising:
identifying, based on historical product data, one or more products from a plurality of products for implementation of a markdown;
receiving, from a user interface, a plurality of market inputs associated with the one or more products;
generating an optimal time period and optimal markdown value associated with the markdown of the one or more products; and
mapping the one or products to a prioritization indication based on the optimal time period and the optimal markdown value.
